(19) United States
(12) Patent Application Publication
(10) Pub. No.: US 2014/0359658 A1
(43) Pub. Date: Dec. 4, 2014

(54) INFORMATION DISPLAY DEVICE AND INFORMATION DISPLAY METHOD

(71) Applicant: Panasonic Corporation, Osaka (JP)

(72) Inventor: Junji YOSHIDA, Osaka (JP)

(21) Appl. No.: 14/457,334

(22) Filed: Aug. 12, 2014

Related U.S. Application Data
(63) Continuation of application No. PCT/JP2012/005848, filed on Sep. 13, 2012.

(30) Foreign Application Priority Data
Feb. 17, 2012 (JP) 2012-032320

(51) Int. Cl. H04N 21/482; H04N 21/81; H04N 21/435

(52) U.S. Cl. CPC H04N 21/482; H04N 21/435; H04N 21/812
USPC 725/32; 725/61

(57) ABSTRACT

An information display device includes: a communication interface which obtains program-related information items related to a video program a user is viewing; a display unit including a metadata display area and a outside-of-time-range advertisement display area; and a control unit which (i) selects, from among the program-related information items obtained by the communication interface, a first program-related information item associated with the video program, and causes the first program-related information item to be displayed in the metadata display area, and (ii) selects, from among one or more of the program-related information items other than the program-related information item selected as the first program-related information item, a second program-related information item, and causes the second program-related information item to be displayed in the outside-of-time-range advertisement display area.

### CROSS REFERENCE TO RELATED APPLICATION

This is a continuation application of PCT International Application No. PCT/JP2012/005848 filed on Sep. 13, 2012, designating the United States of America, which is based on and claims priority of Japanese Patent Application No. 2012-032320 filed on Feb. 17, 2012. The entire disclosures of the above-identified applications, including the specifications, drawings and claims are incorporated herein by reference in their entirety.

### FIELD

The present disclosure relates to information display devices for displaying information related to video programs, such as a currently viewed television program, and to methods of displaying the information.

### BACKGROUND

Information related to a cast or content of a television program is provided by a newspaper or an electronic program guide (EPG).

Patent literature (PTL) 1 discloses a technique in which information related to a cast or content of a television program is created and distributed in chronological order to display, in sync with a currently viewed program, on a mobile terminal, information related to program content according to progress of the program.

Furthermore, PTL 2 discloses a technique in which an advertisement associated with a genre of a currently viewed television program or a keyword mentioned in a currently viewed program is displayed on a mobile terminal.

With these techniques, advertisements can be distributed according to a taste or preference of a viewer.

### CITATION LIST

### Patent Literature

[PTL 1]
Japanese Unexamined Patent Application Publication No. 2011-91675
[PTL 2]
Japanese Unexamined Patent Application Publication No. 2009-303120

### SUMMARY

### Technical Problem

The present disclosure provides an information display device and a method of displaying information which increase opportunities of displaying information related to a video program.

### Solution to Problem

An information display device according to the present disclosure includes: an obtainment unit configured to obtain program-related information items related to a video program a user is viewing; a display unit including a first information display area and a second information display area; and a control unit configured to (i) select, from among the program-related information items obtained by the obtainment unit, a first program-related information item associated with the video program, and cause the first program-related information item to be displayed in the first information display area, and (ii) select, from among one or more of the program-related information items other than the program-related information item selected as the first program-related information item, a second program-related information item, and cause the second program-related information item to be displayed in the second information display area.

### Advantageous Effects

An information display device and a method of displaying information according to the present disclosure makes it possible to increase opportunities of displaying information related to a video program.

### BRIEF DESCRIPTION OF DRAWINGS

These and other objects, advantages and features of the present disclosure will become apparent from the following description thereof taken in conjunction with the accompanying drawings that illustrate a specific embodiment of the present disclosure.

FIG. 1A is a diagram showing a configuration example of a program-related information providing system according to Embodiment 1.

FIG. 1B is a diagram showing an example of a detailed configuration of the program-related information providing system according to Embodiment 1.

FIG. 2 is a diagram showing examples of a program-related information item according to Embodiment 1.

FIG. 3 is a diagram showing a layout example of a display unit of a mobile terminal.

FIG. 4 is a sequence diagram showing a flow of processing among devices included in the program-related information providing system in Embodiment 1.

FIG. 5 shows diagrams for showing an example display of metadata displayed on the display unit of the mobile terminal.

FIG. 6 is a diagram showing another example display of metadata displayed on the display unit of the mobile terminal.

FIG. 7 is a diagram showing a configuration example of a program-related information providing system according to Embodiment 2.

FIG. 8 is a sequence diagram showing a flow of processing among devices included in the program-related information providing system in Embodiment 2.

FIG. 9 is a diagram showing a configuration example of a program-related information providing system according to Embodiment 3.

FIG. 10 is a sequence diagram showing a flow of processing among devices included in the program-related information providing system in Embodiment 3.

FIG. 11 is a diagram showing a configuration example of a program-related information providing system according to Embodiment 4.

FIG. 12 is a diagram showing a layout example of a display unit of a television in Embodiment 4.

FIG. 13 is a sequence diagram showing a flow of processing between devices included in the program-related information providing system in Embodiment 4.

### DESCRIPTION OF EMBODIMENTS

### Circumstances Leading to an Aspect of the Present Disclosure

Use of techniques disclosed in PTL 1 or PTL 2 makes it possible to sequentially display, on a mobile terminal, information or advertisements related to a program according to progress of the program. This is useful in that information related to a scene just displayed can be viewed on the mobile terminal soon.

However, an amount of information that can be displayed on a display panel of the mobile terminal or the like is limited. Thus, for example, information related to scenes at the beginning of a video program disappears from a display screen of the mobile terminal. Depending on an amount of information provided, information can be paged out after a short time.

In particular, when the displayed information is an advertisement, an advertiser demands the advertisement to be displayed on a display panel or the like as long as possible so that a viewer has more chances to view the advertisement. Thus, the advertisement being paged out after a short time is contrary to the wish of the advertiser.

Furthermore, in the case where the viewer begins to watch a program from the middle, a case may occur where an advertisement which is supposed to be displayed at the beginning of the program is never displayed. Furthermore, the case is not limited to an advertisement. If related information which is supposed to be displayed at the beginning of the video program is not displayed, the viewer may fail to obtain (view) information the viewer wishes to obtain.

In view of this, following non-limiting embodiments disclose an information display device which increases, in a program-related information providing system that displays information or an advertisement related to a currently viewed video program, opportunities of displaying for a user, on a television or a mobile terminal, information or an advertisement related to the video program.

The following describes embodiments in detail with reference to drawings when necessary. Note that, details beyond necessity are sometimes omitted. For example, detailed descriptions of matters which are already well known or repeated descriptions for substantially the same configurations may be omitted. This is to avoid making the following descriptions to be unnecessarily redundant, and to facilitate the understanding of those skilled in the art.

It should be noted that the inventor provides the attached drawings and the following descriptions to enable those skilled in the art to sufficiently understand the present disclosure, and do not intend to limit a subject matter described in the CLAIMS by such drawings and the descriptions.

The following describes embodiments according to the present disclosure in detail with reference to drawings. Note that, the same structural elements or the like are denoted with the same reference numerals, and repeated descriptions are omitted.

### Embodiment 1

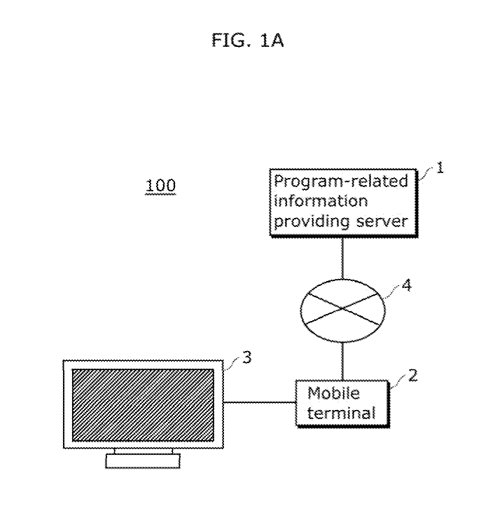

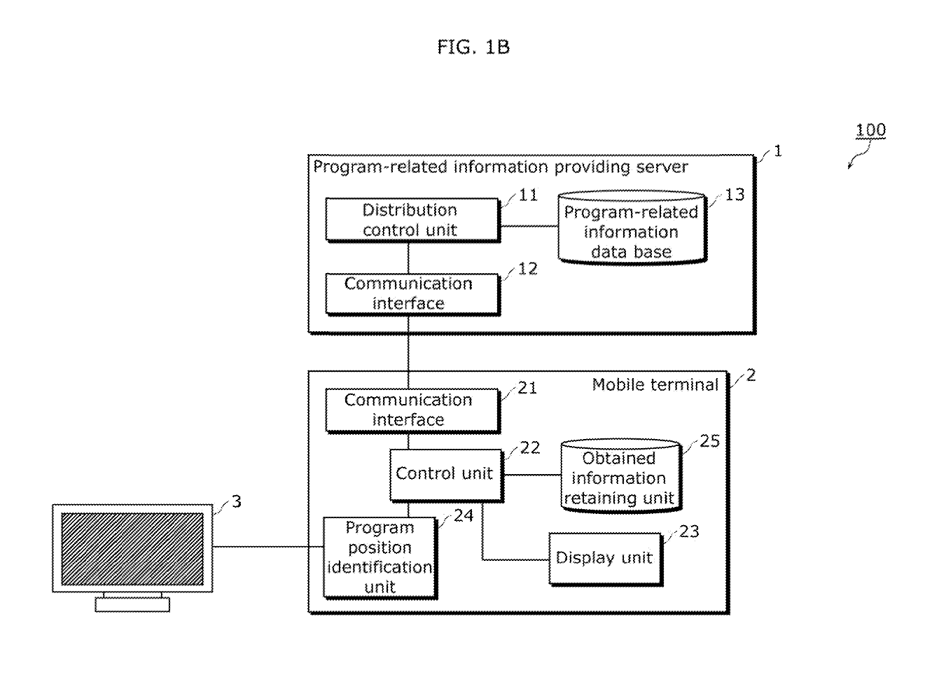

The following describes non-limiting Embodiment 1 using FIG. 1A to FIG. 6.

[1-1. Configuration]

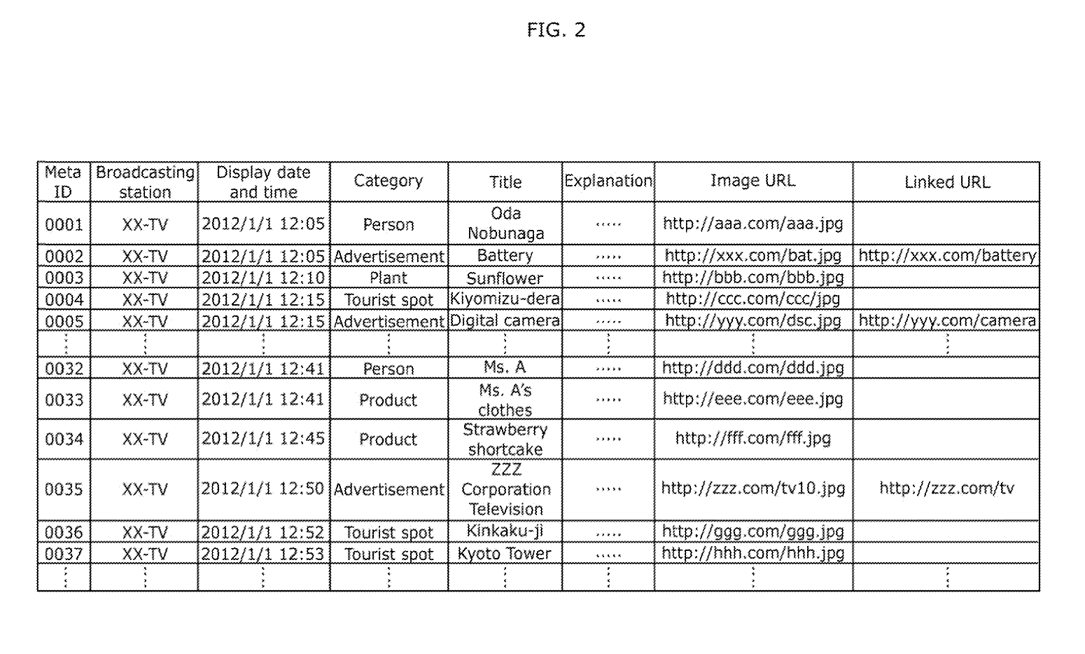

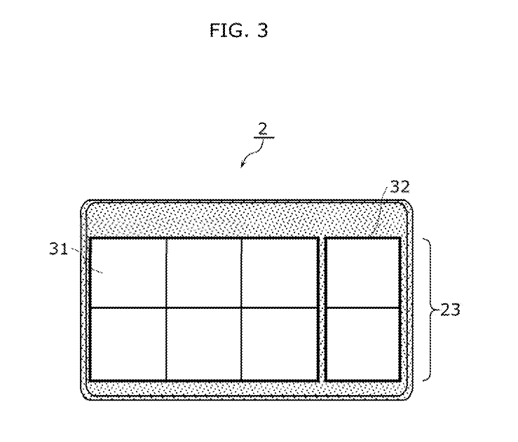

FIG. 1A is a diagram showing an example of a system configuration of a program-related information providing system 100 according to this embodiment. FIG. 1B is a diagram showing an example of a detailed configuration of a program-related information providing system according to Embodiment 1. FIG. 2 is a diagram showing examples of a program-related information item according to Embodiment 1. FIG. 3 is a diagram showing a layout example of a display unit of a mobile terminal 2.

The program-related information providing system 100 includes a program-related information providing server 1, the mobile terminal 2, and a television 3.

The program-related information providing server 1 provides the mobile terminal 2 with a program-related information item related to a video program a viewer is viewing on the television 3. Here, as will be described later, the program-related information item refers to information related to content of a video program, advertisement information sent along with the aforementioned information, or the like. The program-related information providing server 1 includes, as shown in FIG. 1B, a distribution control unit 11, a communication interface 12, and a program-related information data base 13.

When receiving a request (metadata request) for a program-related information item of a video program from the mobile terminal 2 via the communication interface 12, the distribution control unit 11 searches the program-related information data base 13 for or obtains from the program-related information data base 13 metadata of an item (program-related information item) which corresponds to the requested video program (e.g., a broadcasting station and date and time information). The distribution control unit 11 sends the searched or obtained metadata to the mobile terminal 2 via the communication interface 12. Note that, in the case where more than two items (program-related information items corresponding to the video program) are found which correspond to the requested broadcasting station and the date and time information, the distribution control unit 11 sends all of the information items to the mobile terminal 2.

The communication interface 12 is, for example, a local area network (LAN) interface, and can mutually communicate with the mobile terminal 2 via the Internet.

In the program-related information data base 13, for example as shown in FIG. 2, program-related information items (metadata) related to a video program are stored. Here, each of the program-related information items (metadata) includes: metadata ID (meta ID), a broadcasting station which distributes a video program; a date and time (display date and time) at which information related to the meta ID was displayed (appeared) in the video program; a category of the information; a name (title) of the information, explanation about the information; a URL of an image (image URL) in the case where an image related to the information is available; a URL of another link destination (linked URL) in the case where yet another link destination exists; and the like. In FIG. 2, for example, the program-related information item having meta ID 0001 is information about Oda Nobunaga displayed at 12:05 on 2012/1/1 in a video program that is broadcasted by a broadcasting station XX-TV, and it is indicated that an image of Oda Nobunaga exists at http://aaa.com/aaa.jpg.

Note that, the program-related information item (metadata) related to a video program is, not limited to an object, such as a product, a person, an area, or the like displayed as an image in the video program, but is information related to various information included in the video program, such as information about a news, an event, a phenomenon, a service, or the like introduced in the video. Furthermore, the program-related information item (metadata) may include not only advertisement information directly related to a video program, but also include advertisement information distributed during the video program although not directly related to the video program.

For example, in the case of the program-related information items (metadata) shown in FIG. 2, an item having “advertisement” as a category is an advertisement. Then, with the category “advertisement”, it is possible to distinguish an advertisement and information of a type which belongs to a category other than the “advertisement”. The display date and time of the program-related information item having “advertisement” as the category may be designed to be displayed, for example, at a set time as with a television commercial message (CM) or may be designed to be displayed simultaneously with a specific item. Thus, the display date and time may be determined in a varied manner.

The mobile terminal 2 is an example of an information display device, and displays a program-related information item related to a video program (content) a user is viewing. The mobile terminal 2 includes; a communication interface 21, a control unit 22, a display unit 23, a program position identification unit 24, and an obtained information retaining unit 25.

The communication interface 21 communicates with the program-related information providing server 1 through a network using an interface, such as a LAN or the like, in a similar manner as the communication interface 12 of the program-related information providing server 1.

The display unit 23 includes, for example, a liquid crystal screen, and the display area of the display unit 23 includes, on a liquid crystal screen, a metadata display area 31 (first information display area) and an outside-of-time-range advertisement display area 32 (second information display area), as shown in FIG. 3. Furthermore, FIG. 3 shows an example in which the metadata display area 31 can display up to six pieces of metadata, and the outside-of-time-range advertisement display area 32 can display up to two pieces of metadata (advertisement).

The control unit 22 obtains the program-related information items related to the video program the user is viewing. Furthermore, the control unit 22 selects, from among the program-related information items obtained via the communication interface 21, a first program-related information item which is associated with the video program the user is viewing, and causes the first program-related information item to be displayed in the first information display area of the display unit 23. Furthermore, the control unit 22 selects, from among one or more of the program-related information items other than the program-related information item selected as the first program-related information item, a second program-related information item, and causes the second program-related information item to be displayed in the second information display area of the display unit 23. Then, when the control unit selects a new first program-related information item associated with the video program, the control unit 22 updates the first information display area by causing the new first program-related information item to be displayed in the first information display area.

More specifically, the control unit 22 sends a request (metadata request) for a program-related information item of the video program the user is viewing to the program-related information providing server 1 via the communication interface 21. Here, the metadata request specifies, for example, (i) a broadcasting station (distributor) obtained by the program position identification unit 24, (ii) a relative position of a video program the user is currently viewing, in the video program of the broadcasting station (temporal position information in the entirety of the video program), and (iii) a range of information which is related to information included in the video program of the obtained broadcasting station. Note that, a relative position of the video program the user is currently viewing in the video program is, for example, the latest display time of the metadata which is already obtained or a current time. In this manner, as the requested information (metadata range), metadata to be obtained is between the metadata obtained previously and updated metadata before the current obtainment.

When the control unit 22 receives the program-related information item (metadata) related to the video program the user is viewing as a response from the program-related information providing server 1 through the communication interface 21, the control unit 22 stores the received program-related information item in the obtained information retaining unit 25.

Furthermore, the control unit 22 displays the obtained metadata (first program-related information item) in the metadata display area 31 (first information display area) of the display unit 23. When, for example, the metadata display area 31 (first information display area) is filled with metadata (first program-related information item), the control unit 22 avoids displaying old metadata by page feeding or scrolling, and sequentially displays new metadata (first program-related information item) in the metadata display area 31 (first information display area).

The program position identification unit 24 obtains, by communicating with the television 3, information (program identification information) that identifies a video program which is currently selected and viewed by the user on the television 3. Here, information that identifies the video program (program identification information) is information which identifies the video program the television 3 is actually displaying, that is for example, a distributor (broadcasting station), a title of a video program, time information that identifies which portion (temporal position) the currently viewed video program is in the entirety of the video program, or the like. Note that, the program position identification unit 24 communicates with the television 3 via, for example, a LAN.

The obtained information retaining unit 25 records or holds the program-related information item (metadata) which is obtained by the control unit 22 from the program-related information providing server 1 via the communication interface 21.

The television 3 is an example of a video display device, and displays a video program viewed by a viewer (user). Note that, the video program which is displayed on the television 3 and viewed by the user may be any of a video program from among, for example, a video program received through airwaves, a video program reproduced by a video player, a video program reproduced on a cable television.

[1-2. Operations]

The following describes operations performed by the program-related information providing system 100 having the above configuration.

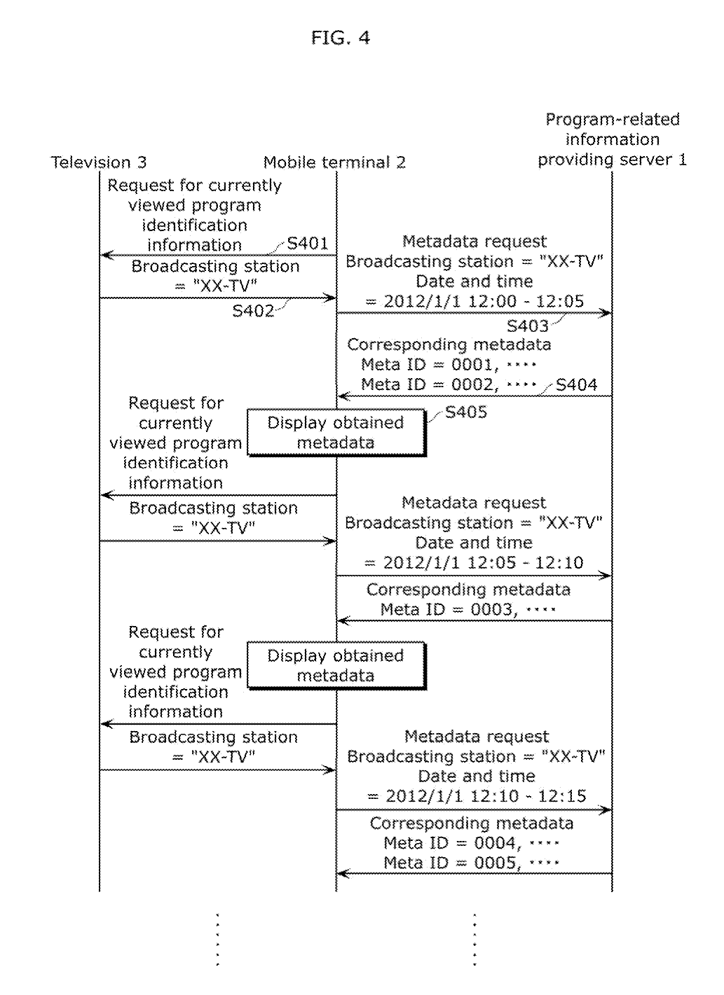

FIG. 4 is a sequence diagram showing a flow of processing among the program-related information providing server 1, the mobile terminal 2, and the television 3 included in the program-related information providing system 100 according to this embodiment.

First, in the mobile terminal 2, the program position identification unit 24 sends, to the television 3, a signal that requests sending of information (program identification information), such as information indicating a currently viewed broadcasting station, or the like, which identifies the video program the viewer is viewing on the television 3 (S401).

Next, the television 3 returns, in response to the request from the mobile terminal 2, information (program identification information), such as information indicating the currently viewed broadcasting station (e.g., a name of a broadcasting station), which identifies a video program that is currently displayed (S402).

Next, when receiving the program identification information from the television 3, the mobile terminal 2 sends, to the program-related information providing server 1, a request (metadata request) for the program-related information item of the video program the user is viewing, based on the received program identification information (a broadcasting station and date and time the video program is viewed, which identify a video program) (S403). Here, for example, the mobile terminal 2 may send, as program identification information, after adding a date and time the program is viewed, the program identification information which is received from the television 3 to the program-related information providing server 1.

Next, in response to the received request of the program identification information (metadata), the program-related information providing server 1 queries (searches) the program-related information data base 13 for (or obtains from the program-related information data base 13) the program-related information item (metadata) related to the video program, and sends the program-related information item (metadata) resulting from the query to the mobile terminal 2 (S404).

Next, the mobile terminal 2 displays, on the display unit 23, the program-related information item (metadata) received from the program-related information providing server 1 (S405).

The subsequent processing is operations in which S401 to S405 are repeated, and thus descriptions thereof are omitted. Note that, sequence shown in FIG. 4 shows an example in which the same processing is periodically repeated, but is not limited thereto. For example, instead of the periodical processing, the processing of S401 to S405 may be performed at a timing desired by the viewer (user).

Furthermore, the mobile terminal 2 may request the program-related information providing server 1 for the program-related information item (metadata) in coordination with or independently of the operation of obtaining the currently viewed broadcasting station from the television 3. FIG. 4 shows an example in which the mobile terminal 2 requests for the program-related information item (metadata) in a cycle range of, for example, five minutes or the like, but is not limited thereto. A longer range (cycle) or a shorter range (cycle) may be employed or a cycle may be of a varied length every time.

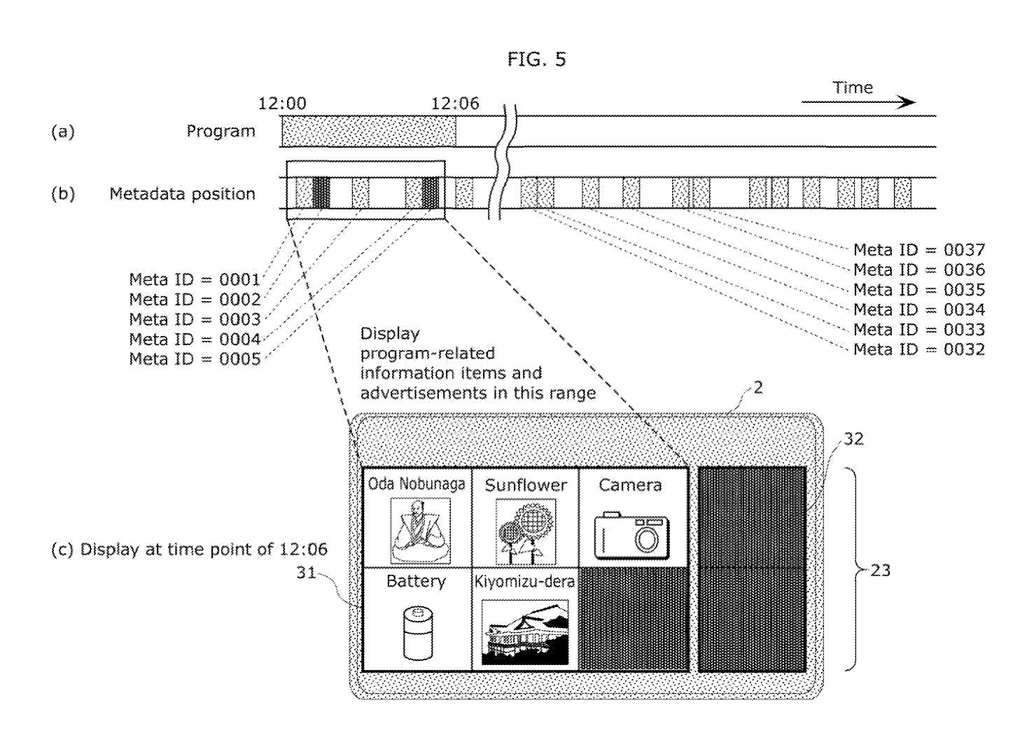

FIG. 5 is a diagram showing an example display of metadata displayed on the display unit 23 of the mobile terminal 2. FIG. 5 shows, as an example, an example display of metadata at time point of 12:06. Note that, at this time point (at 12:06), the mobile terminal 2 has five pieces of metadata (program-related information) having meta IDs 0001 to 0005 as shown in (b) in FIG. 5. Thus, as shown in (c) in FIG. 5, the metadata display area 31 of the display unit 23 displays these five pieces of metadata.

Furthermore, in the display example shown in FIG. 5, at the time point of 12:06, the mobile terminal 2 has only five pieces of metadata having the meta ID 0001 to meta ID 0005. The metadata display area 31 of the mobile terminal 2 can display up to six pieces of metadata. Thus, the mobile terminal 2 is in a state capable of displaying, in the metadata display area 31, all of the obtained metadata (five pieces of metadata). Note that, the outside-of-time-range advertisement display area 32 displays no information at this time point.

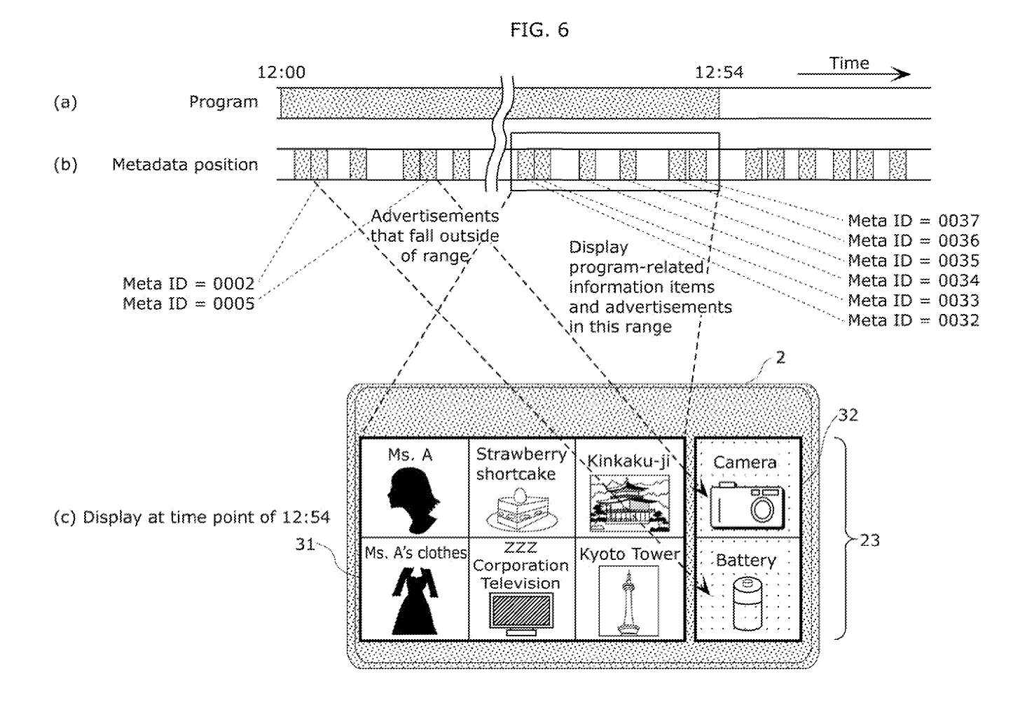

FIG. 6 is a diagram showing another example display of metadata displayed on the display unit 23 of the mobile terminal 2.

FIG. 6 shows an example display of metadata at a time point of 12:54 that is different from the time of display example shown in FIG. 5. At this time point (12:54), as shown in (b) in FIG. 6, the mobile terminal 2 has 37 pieces of metadata (program-related information) having meta IDs 0001 to 0037.

However, the mobile terminal 2 can display up to six pieces of metadata on the metadata display area 31. Thus, the mobile terminal 2 pages out the metadata having the meta IDs 0001 to 0031 to outside the screen to avoid substantial displaying, and displays in the metadata display area 31 only six pieces of metadata having meta IDs 0032 to 0037 as shown in (c) in FIG. 6. In other words, in the metadata display area 31 of the mobile terminal 2, previously displayed metadata is paged out to outside the screen according to progress of a video program, and the metadata associated with content displayed in the video program is displayed.

Furthermore, for example as shown in (c) in FIG. 6, the mobile terminal 2 displays, in the outside-of-time-range advertisement display area 32, the metadata which is not displayed in (is paged out from) the metadata display area 31. In other words, the mobile terminal 2 displays in the outside-of-time-range advertisement display area 32, for example, pieces of metadata 0001 to 0031 which are outside the scope of displaying for the metadata display area 31. This embodiment exemplifies the case where the outside-of-time-range advertisement display area 32 of the display unit 23 is used as an area which displays an “advertisement” as a specific category. More specifically, the outside-of-time-range advertisement display area 32 displays, among meta ID 0001 to meta ID 0031, metadata which falls under “advertisement” in category. Note that, in the case of the example of the metadata (program-related information items) shown in FIG. 2, meta IDs 0002, 0005, and so on fall under “advertisement” that is a specific category displayed in the outside-of-time-range advertisement display area 32.

Note that, there may be a case where the number of candidates of metadata displayed in the outside-of-time-range advertisement display area 32 is greater than the number of items displayable in the outside-of-time-range advertisement display area 32. In this case, the mobile terminal 2 may apply to metadata candidates any display method among, for example, (i) random selection, (ii) displaying with priority on a meta ID having a smaller number, (iii) periodically changing metadata candidate to be displayed.

In other words, the metadata displayed in the outside-of-time-range advertisement display area 32 need not be associated with a video program. For example, in the outside-of-time-range advertisement display area 32, (i) metadata which is previously displayed in the metadata display area 31 may be displayed at certain intervals or (ii) metadata which belong to a specific category may be displayed at predetermined intervals in the previously displayed order or at random different from the previously displayed order. Furthermore, in the outside-of-time-range advertisement display area 32, metadata which is yet to be displayed in the metadata display area 31 and belongs to a specific category may be randomly displayed at certain intervals. As above, the outside-of-time-range advertisement display area 32 may display a program-related information item selected from the program-related information items other than the program-related information item caused to be displayed in the metadata display area 31.

Note that, the program-related information item displayed in the outside-of-time-range advertisement display area 32 and the program-related information item displayed in the metadata display area 31 may partially overlap.

Furthermore, the mobile terminal 2 may use, as content of “advertisement” that is of a specific category displayed in the outside-of-time-range advertisement display area 32, metadata retained in the obtained information retaining unit 25. Furthermore, the mobile terminal 2 may, according to display content (at the time of displaying) of a video program on the television 3, obtain the metadata which belongs to a specific category “advertisement” displayed in the outside-of-time-range advertisement display area 32 again from the program-related information providing server 1. Note that, the specific category is not limited to the above-described “advertisement”. For example, the specific category may be “urgent information” or the like.

Furthermore, the above described the case where the metadata display area 31 displays a latest program-related information item and the outside-of-time-range advertisement display area 32 displays a program-related information item or advertisement information not displayed in the metadata display area 31, this embodiment is not limited thereto.

In other words, the control unit 22 may select arbitrary metadata for the metadata display area 31, and select metadata not displayed in the metadata display area 31 for the outside-of-time-range advertisement display area 32. For example, the control unit 22 may select metadata from, among metadata (candidates) displayable in the outside-of-time-range advertisement display area 32, metadata which having a specific category and cause the selected metadata to be displayed.

Furthermore, the control unit 22 may cause metadata, among metadata caused to be displayed in the metadata display area 31, having an even later (newer) display date and time than metadata having latest (newest) display date and time to be displayed in the outside-of-time-range advertisement display area 32. Alternatively, the control unit 22 may cause metadata, among metadata caused to be displayed in the metadata display area 31, having a later display date and time than metadata having an earliest (oldest) display date and time to be displayed in the outside-of-time-range advertisement display area 32. In other words, the control unit 22 may narrow down (select) metadata based on the above-described element of time for the outside-of-time-range advertisement display area 32, and cause the selected metadata to be displayed in the outside-of-time-range advertisement display area 32.

[1-3. Advantageous Effect, Etc.]

As described above, in this embodiment, the information display device (the mobile terminal 2) includes: an obtainment unit (the communication interface 21) configured to obtain program-related information items related to a video program a user is viewing; a display unit (the display unit 23) including a first information display area (the metadata display area 31) and a second information display area (the outside-of-time-range advertisement display area 32); and a control unit (the control unit 22) configured to (i) select, from among the program-related information items obtained by the obtainment unit, a first program-related information item associated with the video program, and cause the first program-related information item to be displayed in the first information display area, and (ii) select, from among one or more of the program-related information items other than the program-related information item selected as the first program-related information item, a second program-related information item, and cause the second program-related information item to be displayed in the second information display area.

With this, it is possible to provide the information display device which can improve the opportunities of displaying information related to the video program. More specifically, the information display device makes it possible to display, in the first information display area, the first program-related information item selected from among the obtained program-related information items, and display, in the second information display area, the program-related information item not displayed in the first information display area.

Furthermore, each of the program-related information items includes a display date and time indicating a date and a time at which information related to the program-related information item is displayed in the video program.

Here, the control unit (control unit 22) may be configured to select the first program-related information item from, among the program-related information items obtained by the obtainment unit, program-related information items that fall within a predetermined time range based on the display date and time, and select the second program-related information item from, among the program-related information items obtained by the obtainment unit, program-related information items that fall outside of the predetermined time range based on the display date and time.

For example, the control unit may be configured to select the second program-related information item from, among the program-related information items obtained by the obtainment unit, program-related information items that include display times prior to an oldest display time among display times included in two or more of the program-related information items caused to be displayed in the first information display area. Furthermore, the control unit may be configured to select the second program-related information item from, among the program-related information items obtained by the obtainment unit, program-related information items that include display times following a latest display time among display times included in two or more of the program-related information items caused to be displayed in the first information display area.

Furthermore, the above-described predetermined time range may be specified by a user of an information display device (the mobile terminal 2) or a starting time and an end time of the predetermined time range may be, respectively, the latest (newest) display time and the earliest (oldest) display time among the program-related information items caused to be displayed in the first information display area.

More specifically, for example, the control unit may select, as the program-related information item caused to be displayed in the second information display area, a program-related information item having a display time earlier than the start time (display time) of the above-described predetermined time range. Furthermore, oppositely, the control unit may select, as the program-related information item caused to be displayed in the second information display area, a program-related information item having a display time later than the end time of the predetermined time range.

Furthermore, the control unit may be configured to select the second program-related information item from one or more of the program-related information items other than the program-related information item caused to be displayed at least once in the first information display area. For example, as for the program-related information item which is at least once displayed in the first information display area, the control unit records the program-related information item in the obtained information retaining unit again after adding “information confirming that the program-related information item is displayed in the first display area” at least once. Then, the control unit may display, in the second information display area, only information which does not include the “information confirming that the program-related information item is displayed in the first display area”.

In this manner, the program-related information item displayed in the first information display area and the program-related information item displayed in the second information display area may have different display dates and times. With this, the user can simultaneously view the program-related information items having different display dates and times.

Furthermore, the control unit may be configured to select the second program-related information item from, among the one or more of the program-related information items other than the program-related information item selected as the first program-related information item, program-related information items that belong to a specific category. Here, For example, the specific category is an advertisement.

With this, it is possible to increase opportunities of displaying an advertisement related to the video program. In other words, the program-related information item or an advertisement which is not currently displayed in the first information display area with a progress of a program (user operation) can also be displayed to be moderately viewed by the user.

Thus, according to this embodiment, even when the video program the viewer (user) is viewing on the television 3 or the like progresses, and the mobile terminal 2 regards metadata outside the scope of displaying, the viewer (user) can view the metadata (program-related information item) on the display screen of the mobile terminal 2. With this, the viewer (user) can see, on the mobile terminal 2, metadata which corresponds to the video program even at a time other than the display time in the video program. At this time, the metadata which corresponds to the display time of the television 3 or the like is displayed in the metadata display area 31, and the metadata for other than the display time is displayed in the outside-of-time-range advertisement display area 32. This makes it possible for the viewer to simultaneously see, on the mobile terminal 2, metadata having different display times.

Here, in the case where metadata displayed in the outside-of-time-range advertisement display area 32 is advertisement information, the advertisement information can be displayed for the viewer even at a time other than the display date and time corresponding to a video program. Thus, effects as an advertisement can be produced more effectively.

Note that, content of the metadata is not limited to details (parameter) of program-related information items shown in FIG. 2, but may include more parameters. Furthermore, each parameter may be in a format other than the format shown in FIG. 2.

Furthermore, the program-related information data base 13 retains various items (information) that appeared in the television program and advertisements in a mixed manner in one table in FIG. 2, but is not limited thereto. The above-described items and advertisements may be retained in separate tables.

Furthermore, the above describes an example in which, when a plurality of items are found that correspond to a broadcasting station and date and time information for which metadata is requested by the mobile terminal 2, the distribution control unit 11 sends all of the items to the mobile terminal 2, but is not limited thereto. The distribution control unit 11 may send only a part of the items to the mobile terminal 2. With this, information displayed on the mobile terminal 2 may be selected, for example, according to an attribute (sex, age, or the like), a taste or preference of the user.

Furthermore, the display unit 23 may include a display area which displays content other than the metadata display area 31 and the outside-of-time-range advertisement display area 32 is displayed.

Furthermore, an example is described above in which the metadata display area 31 can display up to six pieces of metadata, and the outside-of-time-range advertisement display area 32 can display up to two pieces of metadata (advertisements), but is not limited thereto. The number of pieces of metadata displayable in the metadata display area 31 and the outside-of-time-range advertisement display area 32 may be arbitrarily determined.

Furthermore, the above described that the program-related information item which is not displayed in the metadata display area 31 is displayed in the outside-of-time-range advertisement display area 32, but is not limited thereto. The method of selecting advertisement displayed in the outside-of-time-range advertisement display area 32 may be different from the above description.

For example, the advertisement may be selected from among advertisements scheduled to be displayed in the future relative to the current time point (i.e., the display date and time set for the advertisement is later than the current date and time) or selected from among advertisements which have never been displayed in the metadata display area 31. Furthermore, the metadata which is displayed in the metadata display area 31 before may be designed to be displayable again by a user operation. For example, it is conceivable that the display unit 23 is a touch panel, and the displayed metadata changes with a touch operation (so-called flick operation) performed by the user.

Furthermore, the communication between the mobile terminal 2 and the television 3, and the communication between the mobile terminal 2 and the program-related information providing server 1 may be achieved via a communication unit, such as a mobile phone line, other than via a LAN.

Furthermore, a broadcasting station may be used to identify (i) content viewed on the television 3 or (ii) the metadata. However, for example, ID information which identifies a name of a program or a program may be used.

Furthermore, display time (display date and time) of each item of metadata may be instead of a date and time, relative elapsed time from a start time of a program (e.g., a time point at 5 minutes and 20 seconds from the start of the program).

Furthermore, the program viewed on the television 3 may be a terrestrial digital broadcasting, a broadcast through a broadcasting satellite (BS), a program provided via a cable broadcast, or a program distributed via a video on demand. In the case of the program distributed via the video on demand, metadata may be identified, for example, based on ID information of a program and a relative elapsed time in a program, instead of based on a broadcasting station and date and time information.

### Embodiment 2

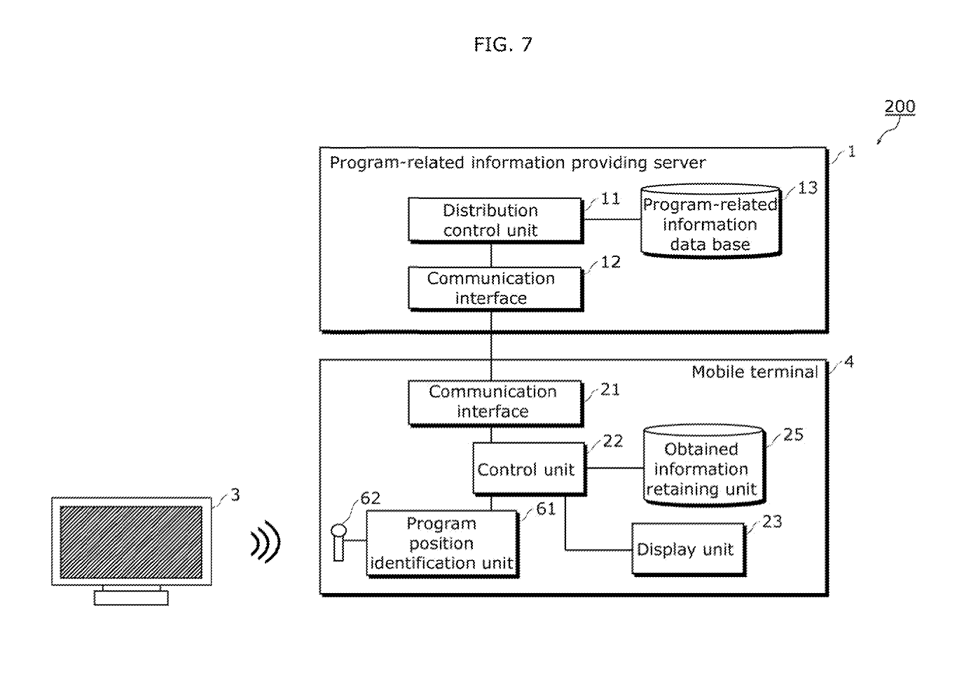

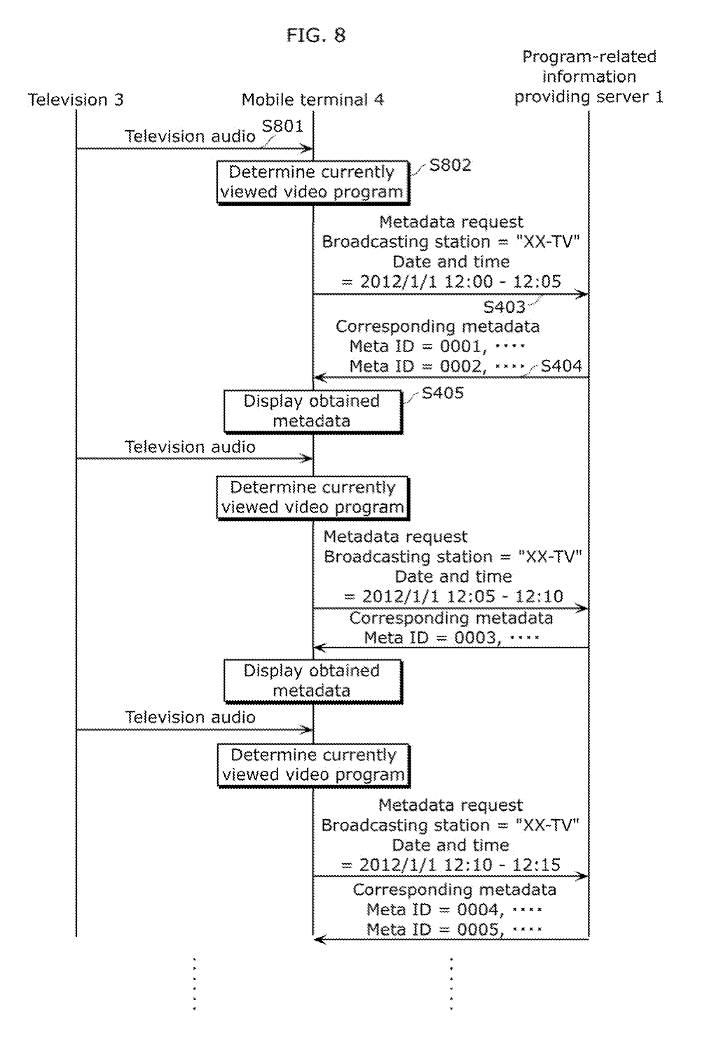

In the following, using FIG. 7 and FIG. 8, an example different from a program-related information providing system described in Embodiment 1 is described as non-limiting Embodiment 2.

[2-1. Configuration]

FIG. 7 is a diagram showing a configuration example of a program-related information providing system 200 according to this embodiment. The program-related information providing system 200 shown in FIG. 7 includes a program-related information providing server 1, a television 3, and a mobile terminal 4.

The program-related information providing system 200 shown in FIG. 7 and a program-related information providing, system 100 described in Embodiment 1 are different in a method used by a mobile terminal 4 to identify a video program viewed on a television 3 by a viewer. The following mainly describes points different from Embodiment 1, and parts the same as parts in Embodiment 1 are denoted with the same reference numerals to omit descriptions thereof.

The program-related information providing server 1 and the television 3 are the same as those in Embodiment 1, and thus descriptions thereof are omitted.

The mobile terminal 4 is an example of an information display device, and displays a program-related information item related to a video program (content) a user is viewing. The mobile terminal 4 includes: a communication interface 21, a control unit 22, a display unit 23, an obtained information retaining unit 25, a program position identification unit 61, and a microphone 62. Note that, the communication interface 21, the display unit 23, and the obtained information retaining unit 25 are the same as configurations of a mobile terminal 2 in Embodiment 1, and thus descriptions thereof are omitted.

The program position identification unit 61 is an example of a program identification unit, and identifies a video program based on audio obtained through the microphone 62.

In other words, the program position identification unit 61 obtains, via the microphone 62, audio that is outputted by the television 3 along with displaying of a video program, and processes the obtained audio. More specifically, the program position identification unit 61 calculates, for example, a value (e.g., a hash value or the like) uniquely determined from the obtained audio signal, and identifies, based on the value, a distributor, a program name, display time in a program or the like of the video program displayed on the television 3. Here, the program position identification unit 61 itself may identify a program name based on a uniquely determined value or the program position identification unit 61 may transmit the calculated value or the like to an external analysis server and receive a program name or the like identified by the external analysis server.

Note that, a method for identifying a program name in this embodiment is not limited to the method described above. It is sufficient that a video program or the like be identified from audio outputted by the television 3.

The microphone 62 obtains audio outputted by the television 3 which displays a video program. More specifically, the microphone 62 obtains audio outputted by the television 3, and converts the audio into an electrical signal. The microphone 62 outputs, to the above-described program position identification unit 61, an audio electrical signal resulting from the conversion.

The control unit 22 is substantially the same as the control unit 22 described in Embodiment 1. For example, the control unit 22 sends, to the program-related information providing server 1 via the communication interface 21, a request (metadata request) for a program-related information item of a video program a user is viewing. Then, the control unit 22 obtains the program-related information item related to the video program the user is viewing. Here, the metadata request specifies, for example, a broadcasting station identified by the program position identification unit 61, and a range of desired metadata that is specified by time (a time position of a video program in the entirety of the video program the user is viewing). The control unit 22 sends such metadata request to the program-related information providing server 1 via the communication interface 21.

As described, the control unit 22 is substantially the same as the control unit 22 described in Embodiment 1, and thus other descriptions are omitted.

[2-2. Operations]

The following describes operations performed by the program-related information providing system 200 having the above-described configuration.

FIG. 8 is a sequence diagram showing a flow of processing among the program-related information providing server 1, the television 3, and the mobile terminal 4 included in the program-related information providing system 200 in this embodiment. Differences between the processing shown in FIG. 8 and the processing shown in FIG. 4 described in Embodiment 1 are portion of processing performed prior to identification of a currently viewed program. The processing (S403 to S405) after identifying the program is the same as S403 to S405 in FIG. 4, and thus descriptions thereof are omitted.

First, the television 3 displays on the display unit 23 a video of a video program a viewer (user) is viewing, and outputs audio of the video program through a speaker (not shown) (S801).

Next, the microphone 62 of the mobile terminal 4 obtains audio outputted from the television 3, and converts the audio into an electrical signal. The microphone 62 outputs an audio electrical signal resulting from the conversion to the program position identification unit 61. The program position identification unit 61 identifies a video program based on a distributor, a program name, a time in the program, or the like, based on the input of the audio electrical signal (S802). Note that, the identification method is not led to the above-described example (a distributor, a program name, and a time in the program) as long as the identification is based on the above-described audio electrical signal.

The subsequent processing (S403 to S405) is the same as the processing in FIG. 4, and thus the descriptions thereof are omitted.

Note that, the mobile terminal 4 repeats the processing of S801 to S802 and S404 to S405 at certain time intervals or as necessary.

[2-3. Advantageous Effect, Etc.]

As described above, according to this embodiment, even when the video program the viewer (user) is viewing on the television 3 or the like progresses, and the mobile terminal 4 regards metadata as outside the scope of displaying, the viewer (user) can view the metadata (program-related information item) on the display screen of the mobile terminal 4. With this, the viewer (user) can see on the mobile terminal 4 metadata corresponding to the video program even at a time other than a display time of the video program. At this time, the metadata which corresponds to the display time of the television 3 or the like is displayed in a metadata display area 31, and metadata for other than the display time is displayed in an outside-of-time-range advertisement display area 32. With this, the viewer can simultaneously see, on the mobile terminal 2, metadata having a different display time.

Furthermore, in the case where metadata displayed in the outside-of-time-range advertisement display area 32 is an advertisement, the advertisement information can be displayed for the viewer even at a time other than the display date and time corresponding to the video program. Thus, effects as an advertisement can be produced more effectively.

Furthermore, in this embodiment, the mobile terminal 4 identifies a video program displayed on the television 3 using a method different from a method described in Embodiment 1. Specifically, in this embodiment, a program is identified based on an audio signal outputted from the television 3. With this, a communication function for sending information to the mobile terminal 4 for identifying a video program becomes unnecessary for the television 3. Thus, even when using a television without a communication function, the viewer can see, using the mobile terminal 4, the program-related information item simultaneously with displaying of a video program on a television.

### Embodiment 3

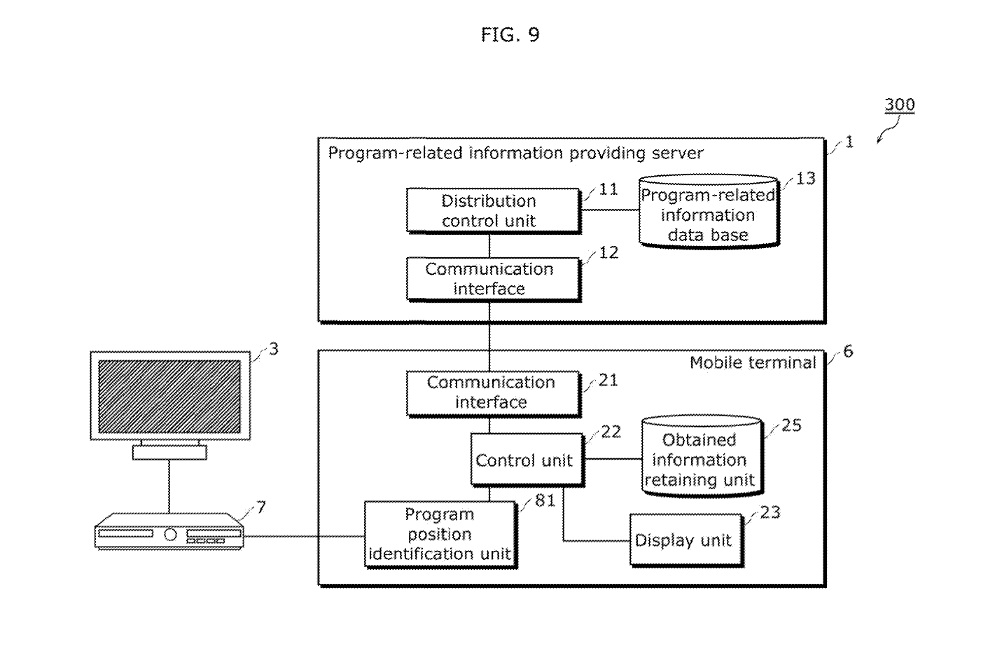

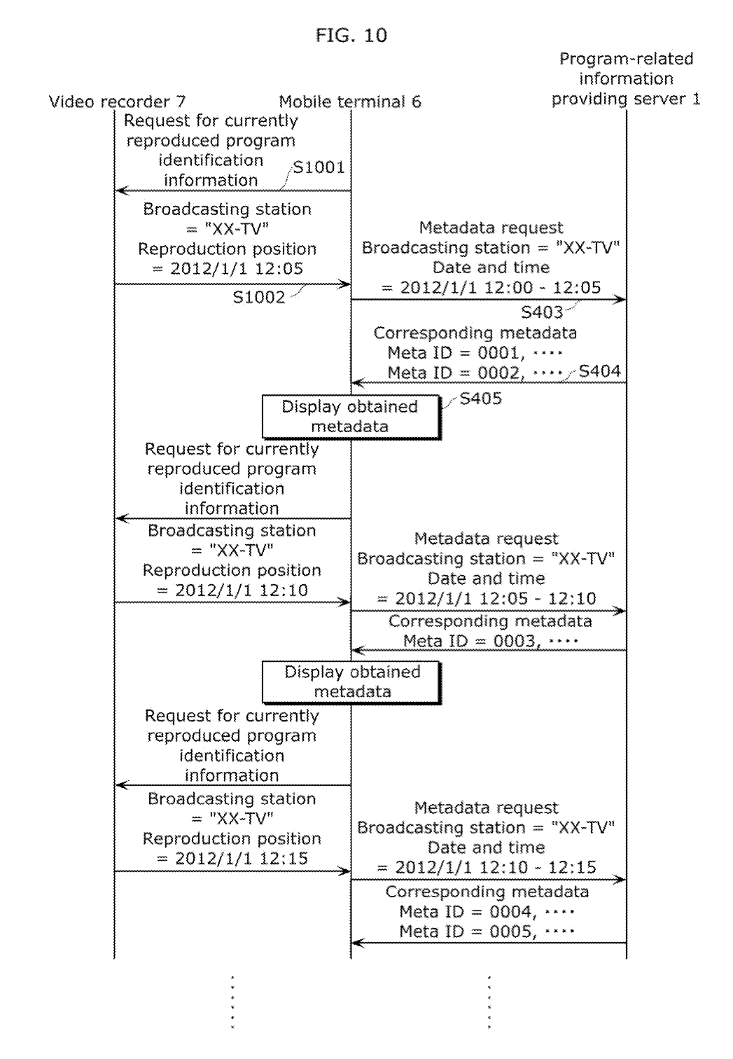

In the following, an example different from program-related information providing systems described in Embodiments 1 and 2 is described as non-limiting Embodiment 3 using FIG. 9 and FIG. 10.

[3-1. Configuration]

FIG. 9 is a diagram showing a configuration example of a program-related information providing system 300 according to this embodiment. The program-related information providing system 300 shown in FIG. 9 includes a program-related information providing server 1, a television 3, a mobile terminal 6, and a video recorder 7.

Different from a program-related information providing system 100 described in Embodiment 1, the program-related information providing system 300 shown in FIG. 9 further includes the video recorder 7, and the mobile terminal 6 communicates with the video recorder 7 to identify a video program displayed on the television 3. The following mainly describes different points compared with Embodiment 1, and the parts the same as the parts described in Embodiment 1 are denoted with the same reference numerals to omit descriptions thereof.

The program-related information providing server and the television 3 are the same as those in Embodiment and thus descriptions thereof are omitted.

The mobile terminal 6 is an example of an information display device, and displays a program-related information item related to a video program (content) a user is viewing. The mobile terminal 6 includes a communication interface 21, a control unit 22, a display unit 23, an obtained information retaining unit 25, and a program position identification unit 81. Note that, the communication interface 21, the display unit 23, and the obtained information retaining unit 25 are the same as those in a mobile terminal 2 described in Embodiment 1 (FIG. 1B), and thus descriptions thereof are omitted.

The control unit 22 sends, via the communication interface 21, a request for the program-related information item (metadata request) of a video program the user is viewing to the program-related information providing server 1. Here, the metadata request specifies, for example, a broadcasting station identified by the program position identification unit 81 or a range (metadata range) of information related to information included in a video program of the identified broadcasting station.

The program position identification unit 81 is an example of a program identification unit, and obtains, by communicating with the video recorder 7 which reproduces a video program, information (program identification information) which identifies a video program displayed by the video recorder 7. More specifically, the program position identification unit 81 obtains, by communicating with the video recorder 7, information (program identification information) including a broadcasting station of a program the video recorder 7 is reproducing, a start date and time of the program, the current reproduction position, or the like, which identifies the video program. The program position identification unit 81 communicates with the video recorder 7, for example, via a LAN.

The video recorder 7 is an example of a video reproduction device, and reproduces a video program which is already recorded. The reproduced video program is displayed on the television 3.

[3-2. Operations]

The following describes operations performed by the program-related information providing system 300 having the above-described configuration.

FIG. 10 is a sequence diagram showing a flow of processing among the program-related information providing server 1, the mobile terminal 6, and the video recorder 7 included in the program-related information providing system 300 in this embodiment. Different from processing shown in FIG. 4 described in Embodiment 1, the partner of communication for the mobile terminal 6 is changed from the television 3 to the video recorder 7 in the processing shown in FIG. 10.

First, the program position identification unit 81 of the mobile terminal 6 sends, to the video recorder 7, a signal which requests sending of information (program identification information) that identifies a currently reproduced video program the viewer is viewing (S1001).

Next, in response to the request from the mobile terminal 6, the video recorder 7 returns, to the program position identification unit 81, program identification information including information, such as a broadcasting station, or the like, which identifies a currently reproduced video program (S1002).

The subsequent processing (S403 to S405) is the same as the processing described in Embodiment 1 (FIG. 4), and thus descriptions thereof are omitted.

[3-3. Advantageous Effect, Etc.]

As described above, according to this embodiment, even when the video program which the viewer (user) is reproducing using the video recorder 7 and viewing on the television 3 or the like progresses, and the mobile terminal 6 regards metadata outside the scope of displaying, the viewer (user) can view the metadata (program-related information item) on the display screen of the mobile terminal 6. With this, the viewer (user) can see, using the mobile terminal 6, metadata which corresponds to the video program even at a time other than the display time in the video program. At this time, the metadata of the display time of a video program reproduced by the video recorder 7 and displayed on the television 3 is displayed in the metadata display area 31, and the metadata for other than the display time is displayed in the outside-of-time-range advertisement display area 32. This makes it possible for the viewer to simultaneously see metadata having a different display time on the mobile terminal 6.

Furthermore, in the case where metadata displayed in the outside-of-time-range advertisement display area 32 is advertisement information, the advertisement information can be displayed even at a time outside of the display date and time which corresponds to a video program. Thus, effects as an advertisement can be produced more effectively.

Note that, this embodiment described a video recorder as an example, but is not limited thereto. Other reproduction apparatus, such as digital versatile disk (DVD) recorder, a Blu-ray Disc (BD, Blu-ray Disc is a registered trademark) recorder, a set-top box (STB), or the like may be used instead of the video recorder. A type of a reproduction apparatus is not limited as long as the mobile terminal 6 can obtain information for identifying a currently reproduced program and a current reproduction position.

Furthermore, the mobile terminal 6 and the video recorder 7 may alp communicate via a communication unit other than a LAN.

### Embodiment 4

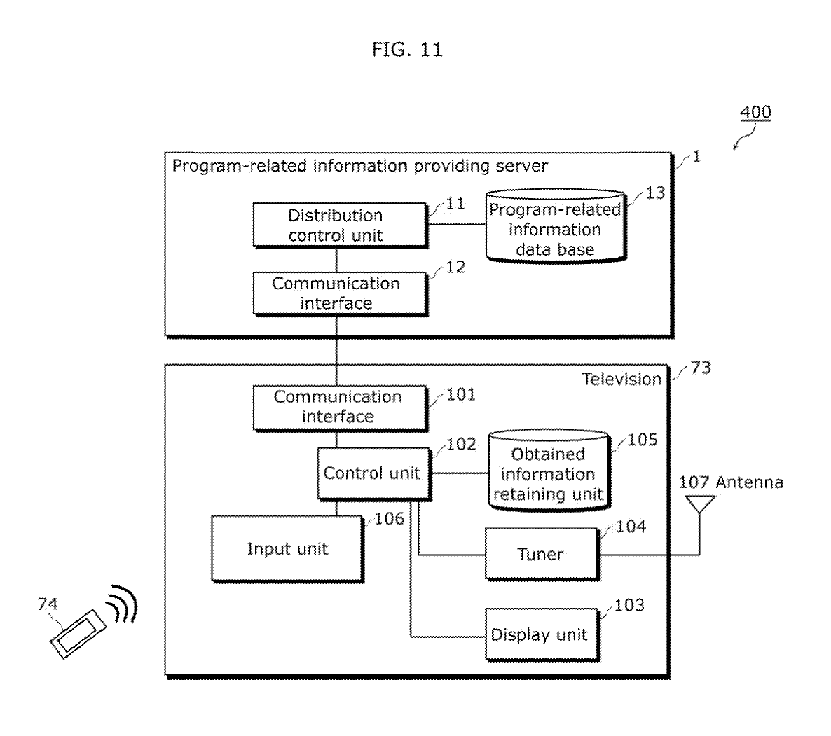

In the following, a different example from a program-related information providing system described in Embodiment 1 is described as non-limiting Embodiment 4 using FIG. 11 to FIG. 13.

[4-1. Configuration]

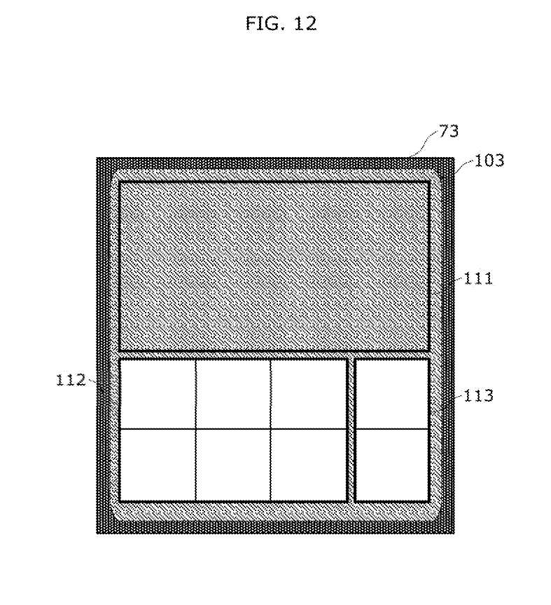

FIG. 11 is a diagram showing a configuration example of a program-related information providing system 400 in this embodiment. FIG. 12 is a diagram showing a layout example of a display unit of a television in this embodiment.

The program-related information providing system 400 shown in FIG. 11 includes a program-related information providing server 1, a television 73, and a remote control 74.

Different from a program-related information providing system 100 described in Embodiment 1, the television 73 in the program-related information providing system 400 shown in FIG. 11 further includes functions performed by a mobile terminal described in Embodiment 1 and so on. The following mainly describes points different from Embodiment 1, and parts the same as parts in Embodiment 1 are denoted with the same reference numerals to omit descriptions thereof.

The program-related information providing server 1 is the same as the program-related information providing server 1 in Embodiment 1, and thus descriptions thereof are omitted.

The television 73 includes: a communication interface 101, a control unit 102, a display unit 103, a tuner 104, an obtained information retaining unit 105 an input unit 106, and an antenna 107.

The communication interface 101 communicates with the program-related information providing server 1, and sends, to the program-related information providing server 1, a distributor, a program name, a display time, or the like of a video program displayed on the television 73. The communication interface 101 receives metadata or the like of the video program from the program-related information providing server 1.

The control unit 102 controls entirety of the television 73, and performs the same control as a control unit 22 (FIG. 1B) described in Embodiment 1. The control unit 102 is different from the control unit 22 in that the control unit 102 identifies a video program displayed on the television 73, and sends it (program identification information which identifies the video program) to the program-related information providing server 1 via the communication interface 101.

The display unit 103 includes, in addition to the above-described first information display area and the second information display area, a video program display area in which a video program is displayed. More specifically, the display unit 103 displays, along with a video program displayed for a viewer (user), metadata or the like received from the program-related information providing server 1.

The display unit 103 includes, for example as shown in FIG. 12: a video area 111 where a video program is displayed; a metadata display area 112 (first information display area) where metadata received from the program-related information providing server 1 is displayed; and an outside-of-time-range advertisement display area 113 (second information display area) where metadata which is received from the program-related information providing server 1 and has a display time that falls outside of a display time range is displayed.

The tuner 104 selects a receiving signal of a video program sent via a broadcast wave from a broadcasting station or the like, and demodulates the receiving signal.

The obtained information retaining unit 105 is the same as an obtained information retaining unit 25 described in Embodiment 1, and thus descriptions thereof are omitted.

The input unit 106 receives a control signal from the remote control 74. The input unit 106 includes, for example when the control signal from the remote control 74 is an infrared signal, a photodiode or the like which receives infrared light. Furthermore, the input unit includes a receiving antenna or the like, when the control signal from the remote control 74 is a radio wave.

The antenna 107 is a receiving element which receives a broadcast wave of a video program sent from a broadcasting station.

[4-2. Operations]

The following describes operations performed by the program-related information providing system 400 having the above-described configuration.

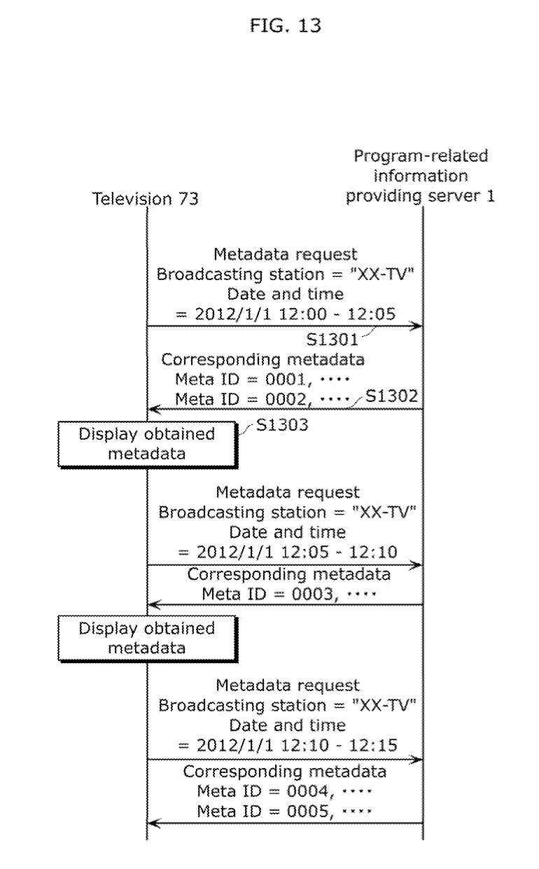

FIG. 13 is a sequence diagram showing a flow of processing between the program-related information providing server 1 and the television 73 included in the program-related information providing system 100 in this embodiment.

First, the television 73 identifies a video program a viewer is viewing, and sends, based on a broadcasting station and date and time the video program is viewed which identify the video program (program identification information), a request (metadata request) for the program-related information item of the video program the user is viewing to the program-related information providing server 1 (S1301).

Next, in response to the received request of program identification information (metadata), the program-related information providing server 1 sends a corresponding program-related information item (metadata) to the television 73 (S1302).

Next, the television 73 displays the received program-related information item (metadata) on the display unit 103. Note that, at this time, the first information display area and the second information display area of the display unit 103 are the same as those in Embodiment 1, and thus descriptions thereof are omitted (S1303).

The subsequent processing is operations in which S1301 to S1303 are repeated, and thus descriptions thereof are omitted.

[4-3. Advantageous Effect, Etc.]

As described above, according to this embodiment even when the video program the user is viewing on the television 73 progresses, and metadata which becomes outside the scope of displaying for the television 73, the viewer (user) can view the metadata (program-related information item) on the display screen of the television 73. With this, the viewer (user) can see, on the television 73, metadata which corresponds to the video program even at a time other than the display time in the video program. At this time, metadata in the display time of the television 73 is displayed in the metadata display area 112, and metadata for other than a display time is displayed in the outside-of-time-range advertisement display area 113. With this, the viewer can simultaneously see, on the television 73, metadata having a different display time.

Furthermore, in the case where metadata displayed in the outside-of-time-range advertisement display area 113 is an advertisement, the advertisement information can be displayed for the viewer even at a time outside of a display date and time corresponding to a video program. Thus, effects as an advertisement can be produced more effectively.

Moreover, in this embodiment, a video viewed by the viewer (user), the first information display area (the metadata display area 112) which displays metadata, and the second information display area (the outside-of-time-range advertisement display area 113) are present in a display screen of the same display unit. This makes it possible for the viewer to see the entire information in one screen.

### Other Embodiments

Non-limiting Embodiments 1 to 4 have been described thus far as examples of a technique disclosed in this application. However, the technique in the present disclosure is not limited to the above-described embodiments and is also applicable to embodiments obtained by making appropriate modification, replacement, addition, omission, etc., to the above-described embodiments. Furthermore, structural elements described in Embodiments 1 to 4 may be combined to provide a new embodiment.

For example, in Embodiment 1 to 4, a communication interface is described as an example of the obtainment unit. It is sufficient that the obtainment unit obtains the program-related information item related to the video program the user is viewing. Thus, the obtainment unit is not limited to the communication interface. Note that, the control unit may also serve as the obtainment unit as long as the program-related information item can be obtained.

Furthermore, the present disclosure includes the following case.

(1) Specifically, each device described above may be achieved by a computer system which includes a microprocessor, a ROM, a RAM, a hard disk unit, a display unit, a keyboard, a mouse, or the like. A computer program is stored in the RAM or the hard disk unit. The operation of the microprocessor in accordance with the computer program allows each device to achieve its functionality. Here, the computer program includes a combination of instruction codes indicating instructions to a computer in order to achieve given functionality.

(2) The structural elements included in each device described above may be partly or wholly realized by one system LSI (Large Scale Integration). A system LSI is a super-multifunction LSI manufactured with a plurality of structural units integrated on a single chip, and is specifically a computer system including a microprocessor, a ROM, a RAM, and so on. A computer program is stored in the ROM. The system LSI achieves its function as a result of the microprocessor loading the computer program from the ROM to the RAM and executing operations or the like according to the loaded computer program.

(3) The structural elements included in each device may be partly or wholly realized by an IC card or a single module that is removably connectable to the device. The IC card or the module is a computer system which includes a microprocessor, a ROM, a RAM, or the like. The IC card or the module may include the above-mentioned super-multifunction LSI. Functions of the IC card or the module can be achieved as a result of the microprocessor operating in accordance with the computer program. The IC card or the module may be tamper resistant.

(4) The present disclosure may be achieved by the methods described above. Moreover, these methods may be achieved by a computer program implemented by a computer, or may be implemented by a digital signal of the computer program.

Moreover, the present disclosure may be implemented using a computer-readable recording medium, such as a flexible disk, a hard disk, a CD-ROM, an MO, a DVD, a DVD-ROM, a DVD-RAM, a Blu-ray Disc (BD, Blu-ray Disc is a registered trademark), a semiconductor memory, or the like, which stores the computer program or the digital signal. Moreover, the present disclosure may be achieved by a digital signal stored in the above mentioned storage medium.

Moreover, in the present disclosure, the computer program or the digital signal may be transmitted via a network represented by an electric communications line, a wireless or wired communications line, or the Internet, as well as data broadcasting, for example.

Moreover, the present disclosure may be a computer system which includes a microprocessor and a memory. In this case, the computer program can be stored in the memory, with the microprocessor operating in accordance with the computer program.

Furthermore, the program or digital signal may be recorded on the recording medium and thus transferred, or the program or the digital signal may be transferred via a network or the like, so that the present disclosure is implemented by another independent computer system.

(5) The above embodiments and the above variations may be combined.

As above, the embodiments are described as examples of the technique according to the present disclosure. The accompanying drawings and detailed descriptions are provided for such a purpose.

Thus, the structural elements described in the accompanying drawings and the detailed descriptions include not only structural elements indispensable to solve a problem but may also include, to exemplify the above-described technique, structural elements not necessarily indispensable to solve a problem. Therefore, structural elements not necessarily indispensable should not be immediately asserted to be indispensable for the reason that such structural elements are described in the accompanying drawings and the detailed descriptions.

Furthermore, above-described embodiments show examples of a technique according to the present disclosure. Thus, various modifications, replacements, additions, omissions, or the like can be made in the scope of CLAIMS or in a scope equivalent to the scope of CLAIMS.

### INDUSTRIAL APPLICABILITY

The present disclosure is applicable to an information display device which can improve opportunities of displaying information related to a video program. More specifically, the present disclosure is applicable to an information providing system or the like which displays, according to a program, on a television or a mobile terminal, information or an advertisement related to a currently viewed television program.

1. An information display device, comprising:
an obtainment unit configured to obtain program-related information items related to a video program a user is viewing;
a display unit including a first information display area and a second information display area and
a control unit configured to (i) select, from among the program-related information items obtained by the obtainment unit, a first program-related information item associated with the video program, and cause the first program-related information item to be displayed in the first information display area, and (ii) select, from among one or more of the program-related information items other than the program-related information item selected as the first program-related information item, a second program-related information item, and cause the second program-related information item to be displayed in the second information display area.

2. The information display device according to claim 1,
wherein when the control unit selects a new first program-related information item according to the video program from among the program-related information items obtained by the obtainment unit, the control unit is configured to update the first information display area by causing the new first program-related information item to be displayed in the first information display area.

3. The information display device according to claim 1,
wherein each of the program-related information items includes a display date and time indicating a date and a time at which information related to the program-related information item is displayed in the video program, and
the control unit is configured to select the first program-related information item and the second program-related information item based on at least the display date and time.

4. The information display device according to claim 3,
wherein the control unit is configured to select the first program-related information item from, among the program-related information items obtained by the obtainment unit, program-related information items that fall within a predetermined time range based on the display date and time, and select the second program-related information item from, among the program-related information items obtained by the obtainment unit, program-related information items that fall outside of the predetermined time range based on the display date and time.

5. The information display device according to claim 1,
wherein the control unit is configured to select the second program-related information item from, among the one or more of the program-related information items other than the program-related information item selected as the first program-related information item, program-related information items that belong to a specific category.

6. The information display device according to claim 5,
wherein the specific category is an advertisement.

7. The information display device according to claim 3,
wherein the control unit is configured to select the second program-related information item from, among the program-related information items obtained by the obtainment unit, program-related information items that include display times prior to an oldest display time among display times included in two or more of the program-related information items caused to be displayed in the first information display area.

8. The information display device according to claim 3,
wherein the control unit is configured to select the second program-related information item from, among the program-related information items obtained by the obtainment unit, program-related information items that include display times following a latest display time among display times included in two or more of the program-related information items caused to be displayed in the first information display area.

9. The information display device according to claim 1,
wherein the control unit is configured to select the second program-related information item from one or more of the program-related information items other than the program-related information item caused to be displayed at least once in the first information display area.

10. The information display device according to claim 1, further comprising
a program identification unit configured to obtain, by communicating with a video display device which displays the video program, information which identifies a video program displayed by the video display device,
wherein the obtainment unit is configured to obtain, based on the information obtained by the program identification unit, a program-related information item related to the video program.

11. The information display device according to claim 1, further comprising
a program identification unit configured to obtain, by communicating with a video reproduction device which reproduces the video program, information which identifies a video program reproduced by the video reproduction device,
wherein the obtainment unit is configured to obtain, based on the information obtained by the program identification unit, a program-related information item related to the video program.

12. The information display device according to claim 1, further comprising:
a microphone which obtains audio outputted by a video display device which displays the video program; and
a program identification unit configured to identify the video program based on the audio obtained by the microphone,
wherein the obtainment unit is configured to obtain a program-related information item related to the video program identified by the program identification unit.

13. The information display device according to claim 10,
wherein the information which identifies the video program includes a title of the video program, and a time position of the video program in an entirety of the video program the user is viewing.

14. The information display device according to claim 1,
wherein the display unit further includes a video program display area in which the video program is displayed.

15. A method of displaying information, comprising:
obtaining program-related information items related to a video program a user is viewing; and
(i) selecting, from among the program-related information items obtained in the obtaining, a first program-related information item associated with the video program, and causing the first program-related information item to be displayed in a first information display area of a display unit, and (ii) selecting, from among one or more of the program-related information items other than the program-related information item selected as the first program-related information item, a second program-related information item, and causing the second program-related information item to be displayed in a second information display area of the display unit.
